(19) United States
(12) Patent Application Publication
(10) Pub. No.: US 2021/0150641 A1
(43) Pub. Date: May 20, 2021

(54) THERMAL LOAD CALCULATION DEVICE

(71) Applicant: YAZAKI ENERGY SYSTEM CORPORATION, Tokyo (JP)

(72) Inventors: Yohsuke YAMADA, Hamamatsu-shi (JP); Motomi INAGAKI, Hamamatsu-shi (JP)

(73) Assignee: YAZAKI ENERGY SYSTEM CORPORATION, Tokyo (JP)

(21) Appl. No.: 17/079,750

(22) Filed: Oct. 26, 2020

(30) Foreign Application Priority Data
Nov. 19, 2019 (JP) 2019-208860

(51) Int. Cl. G06Q 50/06; G06F 30/28

(52) U.S. Cl. CPC G06Q 50/06; G06F 2119/08; G06F 30/28

(57) ABSTRACT

A thermal load calculation device includes a CFD calculation unit to carry out a CFD calculation using first input parameters to obtain a first calculation result, an approximate function generation unit to generate an approximate function based on a plurality of combination data using a response surface methodology by an interpolation method or an approximation method, the appropriate function for calculating the first calculation result based on the plurality of first input parameters, each of the plurality of combination data being a combination of the first calculation result by the CFD calculation unit and the plurality of first input parameters used in the CFD calculation and a thermal load calculation unit configured to calculate the thermal load of the predetermined period in the specific space by using a second calculation result obtained by applying a plurality of second input parameters to the approximate function.

### CROSS-REFERENCE TO RELATED APPLICATION

The present application claims priority to Japanese Patent Application No. 2019-208860 filed on Nov. 19, 2019, the entire content of which is incorporated herein by reference.

### TECHNICAL FIELD

The present invention relates to a thermal load calculation device.

### BACKGROUND

In order to select an air conditioner required for air-conditioning a specific space such as a room of a building (the specific space may be a whole building or a partial space such as a room or the like in the building), a thermal load for a predetermined period (which may be in units of year or in units of season such as summer or winter) in the specific space is calculated (see, for example, JP2015-148863A). By calculating such a thermal load, it is possible to find out, for example, a peak of the load, and as a result, it is possible to properly select an air conditioner that can deal with the peak.

For calculation of the thermal load (hereinafter referred to as ES, an abbreviation for “energy simulation”) in the predetermined period as described above, a heat acquisition amount (or heat loss amount) of the specific space is calculated based on conditions of outside air (solar radiation amount, solar radiation angle, and outside air temperature), building conditions (outer wall, inner wall, ceiling, floor, roof, window, and the like), a ventilation amount, an internal heat source (human, OA equipment, lighting, and the like), and the like. The thermal load (an amount of heat to be removed from air in the specific space or an amount of heat to be supplied to the air in the specific space) can be calculated based on the heat acquisition amount of such a specific space.

It is preferable that such ES is carried out with high accuracy, but in generally in conducting ES, flow of air in the specific space is not considered. That is, in general, ES is carried out with a convective heat conductivity, which is a parameter that affects the flow of air, being a representative value. Therefore, in general, ES is not performed with a high accuracy, and as a result, an air conditioner that can deal with a thermal load which is much greater than an actual thermal load are likely to be selected.

To improve the accuracy of ES, a calculation method that takes into consideration the flow of air by utilizing, or coupling CF (computational fluid dynamics) calculation together with ES is conceivable. In the calculation method, ES is performed using the convective heat conductivity which is determined by CFD-calculation with the same conditions (for example, the same building conditions) as those under which ES has carried out for every calculation step (a series of calculation) of, for example, one hour.

However, the CFD calculation is repeatedly executed until a surface temperature or the like obtained in ES converges at a predetermined value so as to meet consistency with ES for each calculation step. Therefore, the CFD calculation that requires a large amount of calculation load is repeatedly executed, and a calculation load becomes excessive as a whole. In particular, in a case of performing ES for a year, utilization of the CFD calculation together with ES extremely increases the calculation load.

### SUMMARY

Illustrative aspects of the present invention provide a thermal load calculation device configured to reduce a calculation load at the time of thermal load calculation with higher accuracy.

According to an illustrative aspect of the present invention, a thermal load calculation device configured to calculate a thermal load in a specific space within a building over a predetermined period includes a CFD calculation unit configured to carry out a CFD calculation by using a plurality of first input parameters to obtain a first calculation result in which flow of air in the specific space is taken into consideration, the plurality of first input parameters being a plurality of thermal conditions affecting the specific space, an approximate function generation unit configured to generate an approximate function based on a plurality of combination data using a response surface methodology by an interpolation method or an approximation method, the appropriate function for calculating the first calculation result based on the plurality of first input parameters, each of the plurality of combination data being a combination of the first calculation result by the CFD calculation unit and the plurality of first input parameters used in the CFD calculation and a thermal load calculation unit configured to calculate the thermal load of the predetermined period in the specific space by using a second calculation result obtained by applying a plurality of second input parameters to the approximate function.

According to the thermal load calculation device, a combination of a calculation result by a CFD calculation unit and a plurality of input parameters that are used in the CFD calculation for calculating the calculation result, is set as combination data. An approximate function is generated by using a response surface methodology based on a plurality of the combination data. Therefore, once the approximation function is generated by executing CFD calculation for several times, the approximate function can be used hereafter, and thus the calculation load can be reduced. As a result, the calculation load can be reduced even when a thermal load calculation is performed with higher accuracy.

### BRIEF DESCRIPTION OF DRAWINGS

FIG. 1 is a block diagram showing a thermal load calculation device according to an embodiment of the present invention;

FIG. 2 is a conceptual diagram showing a calculation image by a CFD calculation unit shown in FIG. 1;

FIG. 3 is a conceptual diagram showing an example of a plurality of combination data;

FIG. 4 is a conceptual diagram showing an example of an approximate function calculated using a response surface methodology;

FIG. 5 is a conceptual diagram showing a calculation image by an ES unit shown in FIG. 1;

FIG. 6 is a flowchart illustrating processing by a thermal load calculation device according to an embodiment;

FIG. 7 is a flowchart illustrating details of processing by a thermal load calculation device according to a comparative embodiment:

FIG. 8 is a flowchart illustrating details of processing in step S5 shown in FIG. 6;

FIG. 9 is a flowchart illustrating details of processing in step S5 according to another embodiment;

FIG. 10 is a flowchart illustrating details of processing in step S5 according to yet another embodiment;

FIG. 11 is a block diagram showing a thermal load calculation device according to a further embodiment;

FIG. 12 is a flowchart illustrating processing by the thermal load calculation device according to the further embodiment and shows calculation selection processing; and

FIG. 13 is a block diagram showing a thermal load calculation device according to a modification.

### DESCRIPTION OF EMBODIMENTS

Hereinafter, the present invention will be described in accordance with suitable embodiments. The present invention is not limited to the embodiment to be described below and may be appropriately changed without departing from the spirit of the present invention. In the embodiments to be described below, illustration or description of part of configuration may be omitted, but it goes without saying that a publicly known or commonly known technique is appropriately applied to omitted details of a technique within a range where no inconsistency occurs with contents to be described below.

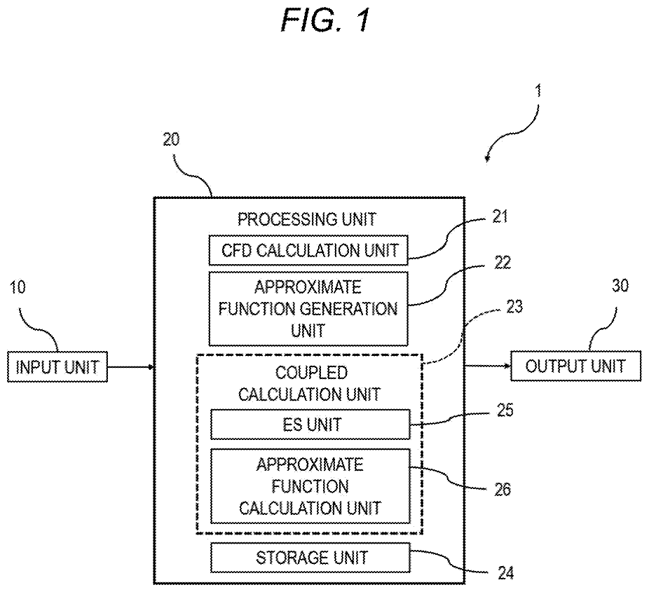

FIG. 1 is a block diagram showing a thermal load calculation device according to an embodiment of the present invention. The thermal load calculation device 1 shown in FIG. 1 calculates a thermal load in a specific space within a building (the specific space may be a whole building or a partial space such as a room in the building) over a predetermined period (may be in units of year or in units of season such as summer or winter), and for example, may be comprised of a personal computer or the like in which a predetermined program is stored. Such a thermal load calculation device 1 includes an input unit 10, a processing unit 20, and an output unit 30.

The input unit 10 includes a handling unit or the like to be handled by a user who uses the thermal load calculation device 1. Various conditions, initial values, and the like are to be input to the input unit 10. The processing unit 20 functions by executing a predetermined program, and includes a CFD calculation unit 21, an approximate function generation unit 22, a coupled calculation unit (thermal load calculation unit) 23, and a storage unit 24. The output unit 30 outputs a calculation result of a thermal load by the coupled calculation unit 23 to the user and includes a display device such as a display or a printing machine of a paper medium such as a printer. The output unit 30 may include a communication unit that outputs a result by an e-mail or the like.

The CFD calculation unit 21, with a surface temperature of a specific space as a plurality of input parameters (first input parameters), performs CFD calculation by using the input parameters, and acquires a convective heat transfer coefficient of a surface portion of the specific space as a calculation result (first calculation result).

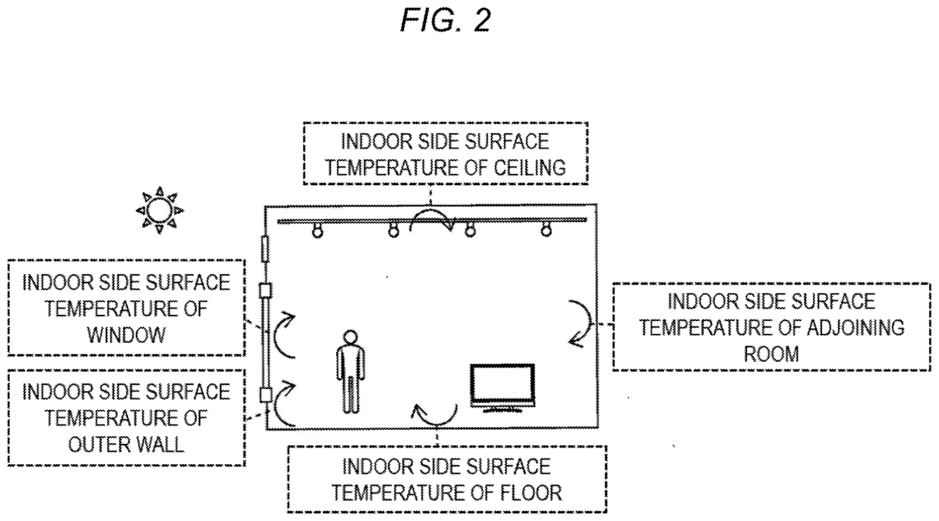

FIG. 2 is a conceptual diagram showing a calculation image by the CFD calculation unit 21 shown in FIG. 1. As shown in FIG. 2, for example, the CFD calculation unit 21, with a surface temperature of each surface (ceiling, floor, wall, window, and the like) of the specific space as an input parameter, performs CFD calculation, with the convective heat transfer coefficient on each surface of the specific space as an output parameter. Thus, the CFD calculation unit 21 calculates the convective heat transfer coefficient on each surface of the specific space.

As described above, the approximate function generation unit 22 generates an approximate function. The approximate function generation unit 22 sets a combination of a calculation result (for example, convection heat transfer coefficients of six surfaces of the specific space) by the CFD calculation unit 21 and a plurality of input parameters (for example, surface temperatures of six surfaces of the specific space) used in the CFD calculation for calculating the calculation result as combination data, and generates an approximate function for calculating a calculation result based on a plurality of input parameters by using a response surface methodology by an interpolation method or an approximation method based on the plurality of combination data.

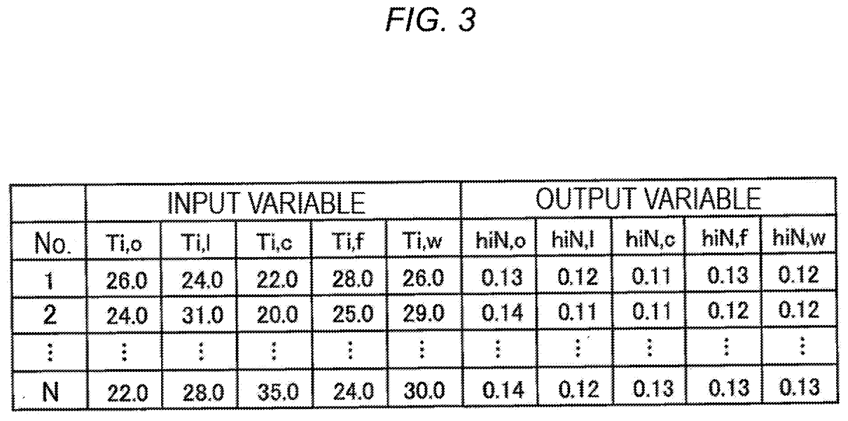

FIG. 3 is a conceptual diagram showing an example of the plurality of combination data. FIG. 3 shows an example of five input parameters and five output parameters.

Now referring to FIG. 3, Ti,o is an indoor side surface temperature of an outer wall. Ti,l is an indoor side surface temperature of a wall separating one's own room (specific space) and an adjoining room thereof, Ti,c is an indoor side surface temperature of a ceiling, Ti,f is an indoor side surface temperature of a floor, and Ti,w is an indoor side surface temperature of a window.

Also, as shown in FIG. 3, hiN,o is a convective heat transfer coefficient of the outer wall, hiN,l is a convective heat transfer coefficient of the wall separating the one's own room (specific space) and the adjoining room, hiN,c is a convective heat transfer coefficient of the ceiling, hiN,f is a convective heat transfer coefficient of the floor, and hiN,w is a convective heat transfer coefficient of the window.

Although the CFD calculation unit 21 calculates the output parameters as described above based on the input parameters as described above. The approximate function generation unit 22 generates an approximate function by using a response surface methodology by an interpolation method or an approximation method based on the plurality of combination data comprised of the input parameters and the output parameters.

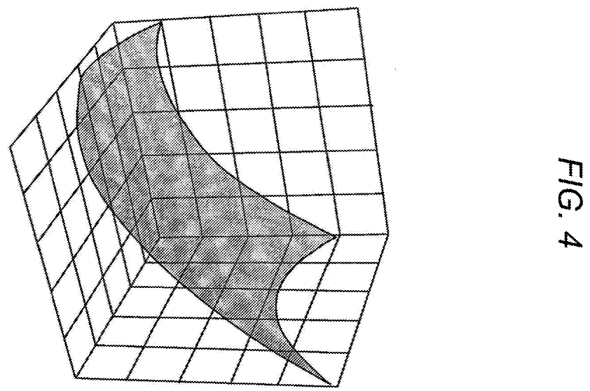

FIG. 4 is a conceptual diagram showing an example of an approximate function calculated using a response surface methodology. Although in FIG. 4, the diagram is depicted three-dimensionally for the sake of illustration convenience, it goes without saying that it may actually be four or more dimensions by matrix calculation or the like. As shown in FIG. 4, the approximate function generation unit 22 generates an approximate function indicating a correlation between the input parameters and the output parameters. Thus, for example, in an example shown in FIG. 3, an approximate function that hiN,o=f {(Ti,o), (Ti,l), (Ti,c), (Ti,f), (Ti,w)} is calculated. The same applies to hiN,l, hiN,c, hiN,f, and hiN,w. The generated approximate function is stored in the storage unit 24 of the processing unit 20.

As shown in FIG. 1, the coupled calculation unit 23 includes an ES unit 25 and an approximate function calculation unit 26, and performs coupled calculation by the ES unit 25 and the approximate function calculation unit 26.

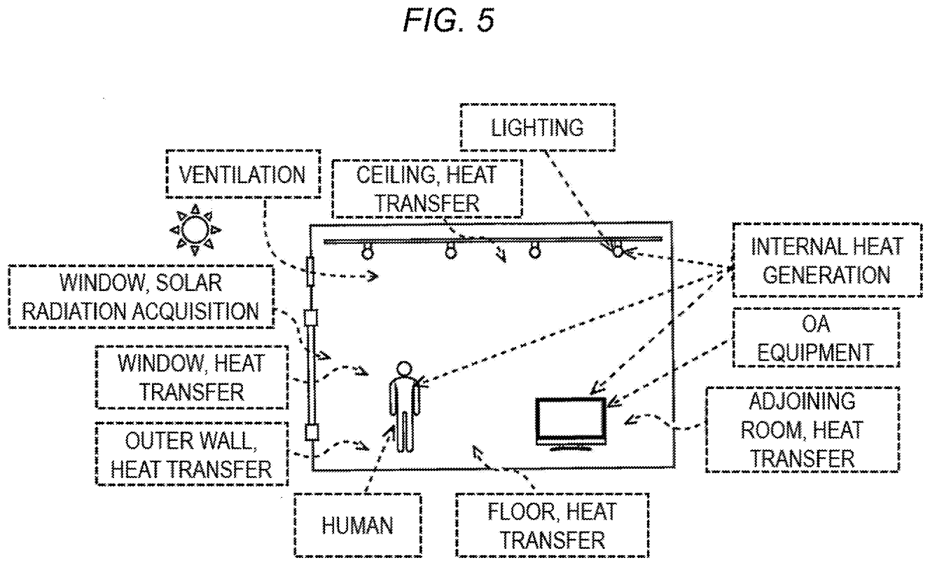

The ES unit 25 calculates a thermal load in the specific space. FIG. 5 is a conceptual diagram showing a calculation image by the ES unit 25 shown in FIG. 1. As shown in FIG. 5, the ES unit 25 calculates a heat acquisition amount (or heat loss amount) of the inside of the building based on predetermined outside air conditions (solar radiation amount, solar radiation angle, and outside air temperature), building conditions (outer wall, inner wall, ceiling, floor, roof, window, and the like), a ventilation amount, an internal heat source (human, OA equipment, lighting, and the like), and calculates the thermal load in the specific space based on the heat acquisition amount (or heat loss amount). The ES unit 25 calculates the thermal load in the specific space for every calculation step (a series of calculation) of, for example, one hour.

The ES unit 25 utilizes a representative value for the convective heat transfer coefficient when the above calculation is performed for the first time. A calculation result of a thermal load calculated only by the ES unit 25 is still provisional, for a coupled calculation (convergent calculation) with the approximate function calculation unit 26 has not yet been carried out. In a process of calculating the thermal load, the ES unit 25 also calculates a surface temperature of the specific space.

The approximate function calculation unit 26 sets the surface temperature of the specific space calculated by the ES unit 25 as a plurality of input parameters (second input parameters), and applies the plurality of input parameters to the approximate function (approximate function stored in storage unit 24) generated by the approximate function generation unit 22 to obtain a calculation result (second calculation result) (convective heat transfer coefficient).

Here, the convective heat transfer coefficient obtained by the approximate function calculation unit 26 is transmitted to the ES unit 25 again. The ES unit 25 calculates the thermal load of the specific space again by using the convective heat transfer coefficient obtained by the approximate function calculation unit 26. The surface temperature is also calculated in this calculation process. When a current surface temperature calculated here is different from a previous surface temperature that has been already calculated by a predetermined value or more than the predetermined value, the processing is executed repeatedly until consistency is met (until the surface temperature calculated by the ES unit 25 converges at a predetermined value). That is, when the current surface temperature is different from the previous surface temperature by a predetermined value or more, the thermal load calculation device 1 causes the approximate function calculation unit 26 to acquire again the convective heat transfer coefficient at the surface portion of the specific space by setting the current surface temperature as the input parameter. After the acquisition, the approximate function calculation unit 26 transmits the acquired convective heat transfer coefficient to the ES unit 25 again, and the ES unit 25 calculates the surface temperature of the specific space again by using the convective heat transfer coefficient acquired by the approximate function calculation unit 26. Thereafter, the above processing is repeated until a difference between the currently calculated surface temperature and the previously calculated surface temperature becomes less than a predetermined value (on all surfaces of the specific space).

The ES unit 25 and the approximate function calculation unit 26 execute the above processing for every calculation step. Here, in the related art, the coupled calculation is performed by the CFD calculation unit 21 and the ES unit 25 since there is no approximate function calculation unit 26. As a result, a calculation amount for CFD calculation is enormous, and since calculation is to be repeatedly executed until consistency is met as described above. Therefore, coupling ES and CFD calculations increases calculation load in the related art.

The thermal load calculation device 1 according to the embodiment obtains calculation results by inputting a plurality of input parameters to the CFD calculation unit 21 in advance and calculates/obtains, based on these results, an approximate function using the response surface methodology by the approximate function generation unit 22. As a result, the coupled calculation unit 23 can perform calculation using the approximate function generated by the approximate function generation unit 22 and avoids taking long time for calculation, which is often the case with CFD calculation.

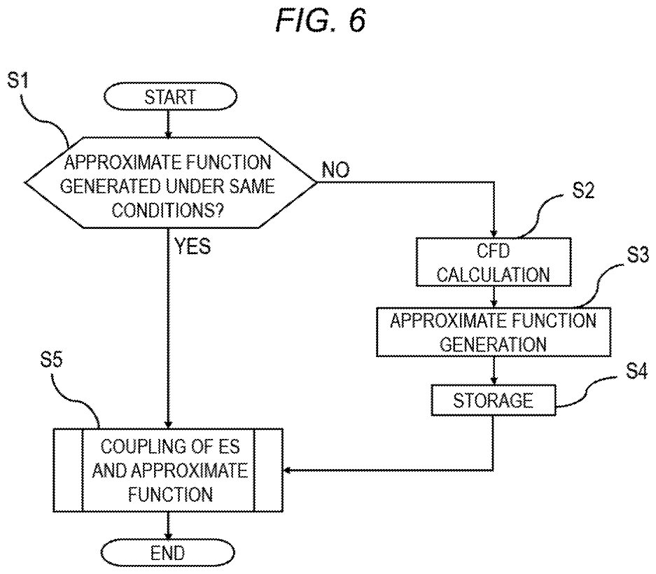

Next, processing of the thermal load calculation device 1 according to the embodiment will be described. FIG. 6 is a flowchart illustrating processing of the thermal load calculation device 1 according to the embodiment. First, as shown in FIG. 6, the processing unit 20 of the thermal load calculation device 1 determines whether an approximate function has been generated under the same conditions in the past (conditions are, for example, specification of the specific space (for example, building conditions), thermal conditions that affect the specific space, the input parameter and the output parameter) (S1). Here, the same conditions mean that for example, the building conditions and the thermal conditions that affect the specific space substantially coincide with those in the past, and a plurality of input parameters and output parameters are substantially the same as those in the past. That is, when the building conditions and the thermal conditions that affect the specific space substantially coincide, when the type of an input parameter (first input parameter) of an approximate function generated in the past is the same as the type of an input parameter (second input parameter) that is to be used for a present calculation, and when an output parameter of the approximate function generated in the past is the same as an output parameter to be output by the present calculation, “YES” is to be chosen in step S1.

As described with reference to FIG. 4, the approximate function generation unit 22 generates an approximate function being hiN,o=f {(Ti,o), (Ti,l), (Ti,c), (Ti,f), (Ti,w)}. Therefore, in step S1, there is no need that the output parameters are completely the same. That is, as long as the plurality of input parameters coincide with those in the past, if an approximate function of six output parameters is generated in the past and only five output parameters are required in the current processing, “YES” may be chosen in step S1.

When the approximate function has not been generated under the same conditions in the past (S1: NO), a great number of the plurality of input parameters (first input parameters) are input to the CFD calculation unit 21 to acquire a great number of calculation results (convective heat transfer coefficients) (S2). Next, the approximate function generation unit 22 generates an approximate function by applying a response surface methodology based on the calculation results of step S2 (S3). Next, the storage unit 24 stores the approximate function generated in step S3 (S4). Thereafter, the processing proceeds to step S5.

When the approximate function has been generated under the same conditions in the past (S1: YES), a thermal load is calculated using the already generated approximate function (S5). That is, the coupled calculation unit 23 (the ES unit 25 and the approximate function calculation unit 26) calculates the convective heat transfer coefficient by applying a plurality of input parameters (second input parameters) to the approximate function and calculates a thermal load for a predetermined period in the specific space by using the convective heat transfer coefficient (S5). Thereafter, the processing shown in FIG. 6 ends.

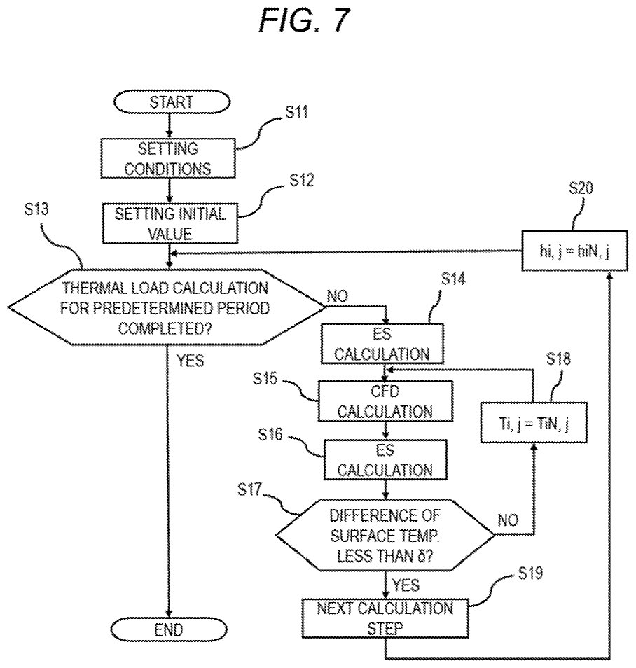

FIG. 7 is a flowchart illustrating details of processing of a thermal load calculation device according to a comparative embodiment. The thermal load calculation device according to the comparative embodiment does not include the approximate function generation unit 22 and the approximate function calculation unit 26, and the coupled calculation unit 23 is comprised of the ES unit 25 and the CFD calculation unit 21. In the thermal load calculation device according to the comparative embodiment, first, setting of conditions such as the building conditions or the thermal conditions that affect the specific space is performed via the input unit 10 (S11).

Next, an initial value is set via the input unit 10 (S12). In the processing, a length of a calculation step (for example, one hour) and a convective heat transfer coefficient hi,j which is a representative value in each part are set.

Thereafter, the processing unit 20 determines whether calculation of a thermal load over a predetermined period has been completed (S13). When the calculation of the thermal load over the predetermined period has not been completed (S13: NO), the ES unit 25 calculates a thermal load of the specific space based on the conditions and the initial value set in step S11 and step S12 (S14). In particular, in the first processing of step S14, the thermal load is calculated by using the convective heat transfer coefficient hi,j which is a representative value. In the processing, a surface temperature Ti,j of the specific space is also calculated in a calculation process of the thermal load.

Next, the CFD calculation unit 21 carries out a CFD-calculation with the surface temperature Ti,j of the specific space as the input parameter and calculates the convective heat transfer coefficient hiN,j at a surface portion of the specific space (S15).

Thereafter, the ES unit 25 calculates the thermal load of the specific space again by using the convective heat transfer coefficient hiN,j calculated in step S15 (S16). In the processing, the surface temperature TiN,J of the specific space is also calculated.

Thereafter, the coupled calculation unit 23 determines whether an absolute value of a difference between the surface temperature TiN and the surface temperature Ti,j is less than a predetermined value δ (S17). When the absolute value of the difference between the surface temperature TiN,j, and the surface temperature Ti,j is not less than the predetermined value δ (S17: NO), the coupled calculation unit 23 sets the surface temperature TiN,J as the surface temperature Ti,j (S18). Thereafter, the processing proceeds to step S15. Hereafter, processing of step S15 to step S18 are repeatedly executed until “YES” is chosen in step S17.

On the other hand, when the absolute value of the difference between the surface temperature Ti,j and the surface temperature TiN,j is less than the predetermined value δ (S17: YES), the coupled calculation unit 23 proceeds to the next calculation step (S19). Next, the coupled calculation unit 23 sets the convective heat transfer coefficient hiN,j as the convective heat transfer coefficient hi,j (S20). Then, the processing proceeds to step S13.

When the calculation of the thermal load over the predetermined period has been completed (S13: YES), the processing shown in FIG. 7 ends.

In the processing according to the comparative embodiment as described above, since coupled calculation is performed by the CFD calculation unit 21 and the ES unit 25, and convergence calculation is performed so as to meet consistency, the calculation load becomes enormous.

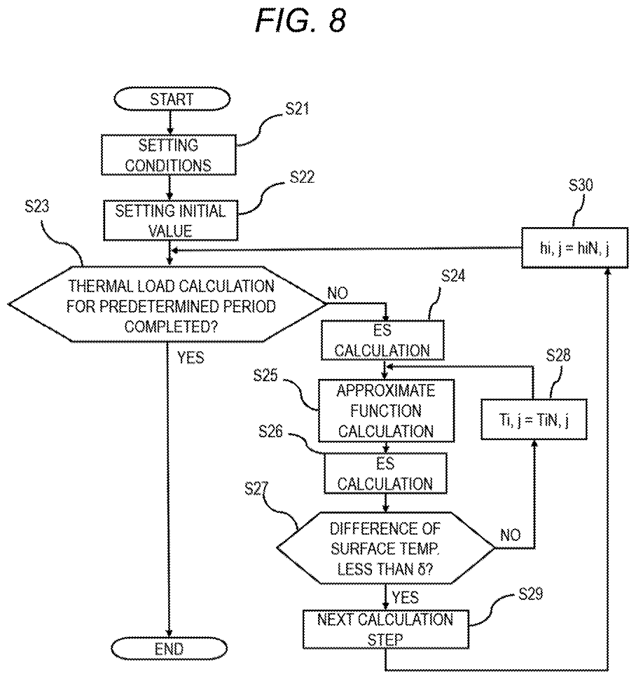

FIG. 8 is a flowchart illustrating details of processing in step S5 shown in FIG. 6. In coupled calculation of the coupled calculation unit 23 (the ES unit 25 and the approximate function calculation unit 26) according to the present embodiment, first, in steps S21 to S24, the same processing as steps S11 to S14 shown in FIG. 7 is executed.

Next, in step S25, the approximate function calculation unit 26 applies the surface temperature Ti,j of the specific space as the input parameter to the approximate function generated by the approximate function generation unit 22, and calculates the convective heat transfer coefficient hiN,j at the surface portion of the specific space (S25).

Thereafter, in processing of steps S26 to S30, the same processing as steps S16 to S20 shown in FIG. 7 is executed.

As is clear from FIG. 8, since an approximate function is used, instead of CFD calculation, in processing of step S25, a calculation load is significantly reduced.

In this way, according to the thermal load calculation device 1 according to the embodiment, a combination of a calculation result by the CFD calculation unit 21 and the plurality of input parameters used in CFD calculation for calculating the calculation result is set as combination data, and the approximate function is generated by using a response surface methodology based on the plurality of the combination data, and the approximate function can be used hereafter, as long as CFD calculation has been executed several times to generate the approximation function. As a result, the calculation load can be reduced. In this way, the calculation load can be reduced at the time of thermal load calculation with higher accuracy.

Further, since a convective heat transfer coefficient is obtained as the calculation result in the CFD calculation, usage the CFD calculation itself can be limited to calculation of a convective heat transfer coefficient which affects flow of air to reduce the calculation amount by means of the CFD calculation and the calculation load can be suitably reduced depending on conditions.

Next, another embodiment of the present invention will be described. A thermal load calculation device according to the another embodiment is similar to that of the embodiment, but has some different processing contents. Hereinafter, differences from the first embodiment will be described.

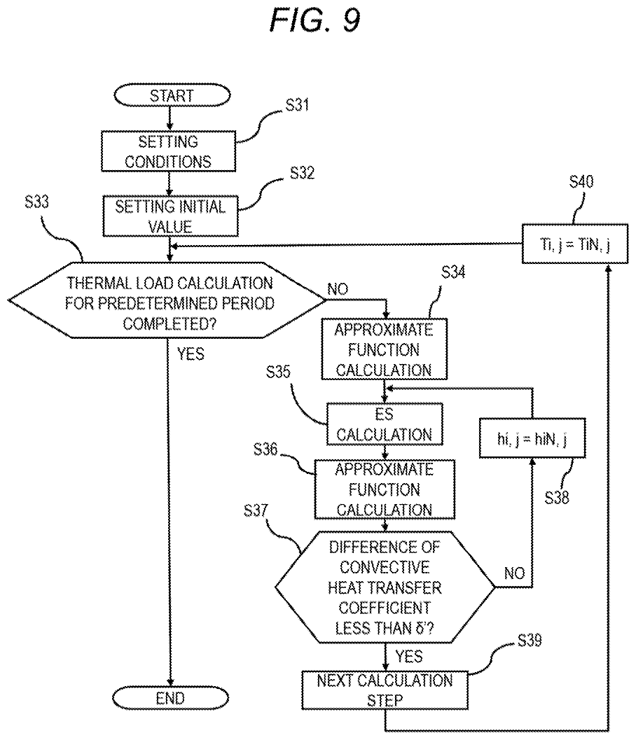

FIG. 9 is a flowchart illustrating details of processing in step S5 according to another embodiment. In coupled calculation of the coupled calculation unit 23 (the ES unit 25 and the approximate function calculation unit 26), first, setting of conditions such as the building conditions or the thermal conditions that affect the specific space is performed via the input unit 10 (S31).

Next, an initial value is set via the input unit 10 (S32). In the processing, a calculation step and the surface temperature Ti,j which is a representative value in each part are set.

Thereafter, the processing unit 20 determines whether calculation of a thermal load over a predetermined period has been completed (S33). When the calculation of the thermal load over the predetermined period has not been completed (S33: NO), the approximate function calculation unit 26 applies the surface temperature Ti,j of the specific space as the input parameter to the approximate function generated by the approximate function generation unit 22, and calculates the convective heat transfer coefficient hiN,j at the surface portion of the specific space (S34).

Thereafter, the ES unit 25 calculates an indoor thermal load based on the conditions set in step S31 and the convective heat transfer coefficient hi,j at the surface portion of the specific space (S35). In the processing, the surface temperature TiN,J of the specific space is also calculated.

Next, the approximate function calculation unit 26 applies the surface temperature TiN,J of the specific space to the approximate function again as the input parameter, and calculates the convective heat transfer coefficient hiN,j at the surface portion of the specific space (S36).

Thereafter, the coupled calculation unit 23 determines whether an absolute value of a difference between the convective heat transfer coefficient hiN,j and the convective heat transfer coefficient hi,j is less than a predetermined value δ (S37). When the absolute value of the difference between the convective heat transfer coefficient hiN,j and the convective heat transfer coefficient hi,j is not less than the predetermined value δ′ (S37: NO), the coupled calculation unit 23 sets the convective heat transfer coefficient hiN,j as the convective heat transfer coefficient hi,j (S38). Thereafter, the processing proceeds to step S35. Hereafter, processing of step S35 to step S38 are repeatedly executed until “YES” is chosen in step S37.

When the absolute value of the difference between the convective heat transfer coefficient hiN,j and the convective heat transfer coefficient hi,j is less than the predetermined value δ′(S37: YES), the coupled calculation unit 23 proceeds to the next calculation step (S39). Next, the coupled calculation unit 23 sets the surface temperature TiN,j as the surface temperature Ti,j (S40). Then, the processing proceeds to step S33.

In addition, when the calculation of the thermal load over the predetermined period has been completed (S33: YES), the processing shown in FIG. 9 ends.

As is clear from FIG. 9, since an approximate function is used instead of CFD calculation in processing of step S34 and S36 in the another embodiment, a calculation load is significantly reduced.

In this way, according to the thermal load calculation device 1 according to the another embodiment, the calculation load can be reduced at the time of thermal load calculation with higher accuracy. Further, a calculation amount of the CFD calculation itself can be reduced, and the calculation load can be suitably reduced depending on conditions.

Next, a yet another embodiment of the present invention will be described. A thermal load calculation device according to the yet another embodiment is similar to that of the embodiment, but has some different processing contents. Hereinafter, differences from the embodiment will be described.

In the yet another embodiment, the number of input parameters of CFD calculation is larger than that in the embodiment. That is, the CFD calculation unit 21 sets at least one of external thermal factors (for example, outside air temperature, solar radiation, building conditions, and adjoining room conditions) and internal thermal factors (for example, heat generation by a human and an OA equipment, or the like) of the specific space in addition to the surface temperature of the specific space as the plurality of input parameters, performs CFD calculation by using the plurality of input parameters, and acquires in-space temperature and humidity considering flow of air in the specific space, as a calculation result. The outside air temperature and the solar radiation are to be considered, preferably (preferably set as the input parameters).

The approximate function generation unit 22 according to the yet another embodiment generates an approximate function by using a response surface methodology by an interpolation method or an approximation method based on the plurality of combination data comprised of the plurality of input parameters and the calculation result of the CFD calculation unit 21 with an increased number of input parameters.

In the yet another embodiment, even though calculation load of CFD calculation is increased, since the in-space temperature and humidity are determined, convergent calculation for meeting consistency is not required.

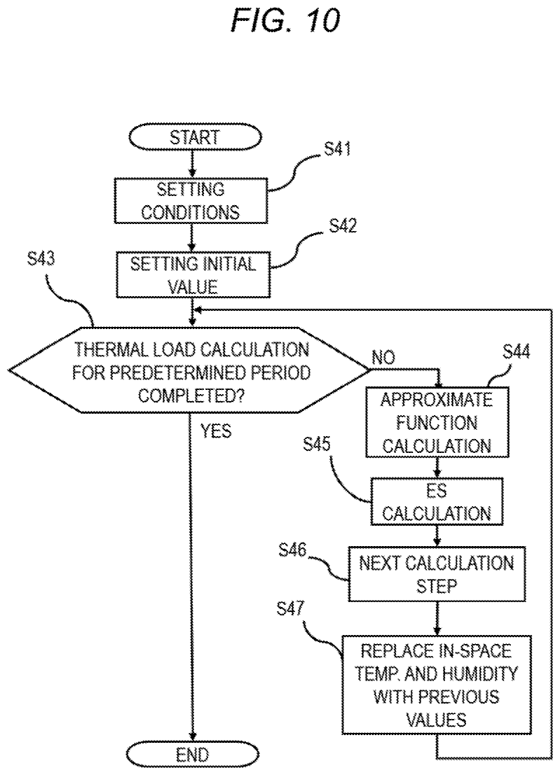

FIG. 10 is a flowchart illustrating details of processing in step S5 according to the yet another embodiment. In the yet another embodiment, in coupled calculation of the coupled calculation unit 23 (the ES unit 25 and the approximate function calculation unit 26), first, setting of conditions such as the building conditions or the thermal conditions that affect the specific space is performed via the input unit 10 (S41).

Next, an initial value is set via the input unit 10 (S42). In the processing, a length of a calculation step (for example, one hour) and the in-space temperature and humidity which is a representative value in each part are set.

Thereafter, the processing unit 20 determines whether calculation of a thermal load over a predetermined period has been completed (S43). When the calculation of the thermal load over the predetermined period has not been completed (S43: NO), the approximate function calculation unit 26 sets the conditions and initial value set in step S41 and step S42 or values (surface temperature, external thermal factors, and internal thermal factors) calculated based on these conditions and initial value as the plurality of input parameters, applies the plurality of input parameters to the approximate function generated by the approximate function generation unit 22, and calculates the in-space temperature and humidity for which flow of air in the specific space is taken into consideration (S44).

Next, the ES unit 25 calculates the thermal load based on the in-space temperature and humidity calculated by the approximate function calculation unit 26 (S45). Thereafter, the coupled calculation unit 23 proceeds to the next calculation step (S46). Next, the coupled calculation unit 23 replaces the currently calculated in-space temperature and humidity with corresponding values which have been previously obtained (S47). As a result, in processing of the next step S44, the in-space temperature and humidity currently calculated is used. Thereafter, the processing proceeds to step S43. When it is determined in step S43 that the calculation of the thermal load over the predetermined period has been completed (S43: YES), the processing of FIG. 10 ends.

In this way, according to the thermal load calculation device 1 according to the yet another embodiment, similarly to the embodiment, the calculation load can be reduced at the time of thermal load calculation with higher accuracy.

Further, in the CFD calculation, at least one of the external thermal factors and the internal thermal factors of the specific space is set as the plurality of input parameters in addition to the surface temperature of the specific space. The in-space temperature and humidity for which flow of air in the specific space is take into consideration is acquired as a calculation result to generate the approximate function. Therefore, once the approximate function has been generated, the calculation load related to calculation of the thermal load can be greatly reduced thereafter.

Next, a further embodiment of the present invention will be described. A thermal load calculation device 2 according to the further embodiment is similar to the thermal load calculation device 1 according to the embodiment and the yet another embodiment, but configuration and processing contents are partially different. The further embodiment will be described below.

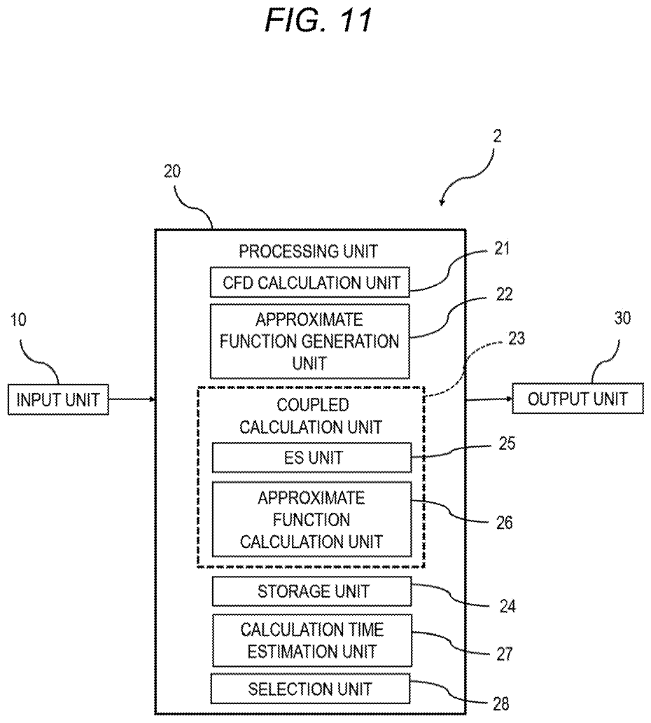

FIG. 11 is a block diagram showing the thermal load calculation device 2 according to the further embodiment. As shown in FIG. 11, the thermal load calculation device 2 according to the further embodiment includes a calculation time estimation unit 27 (calculation time estimation means) and a selection unit 28 (selection means) in addition to the elements shown in FIG. 1.

The calculation time estimation unit 27 estimates time required for calculation by the CFD calculation unit 21, generation of an approximate function by the approximate function generation unit 22, and calculation by the coupled calculation unit 23 described in the first embodiment (first calculation) and time required for calculation by the CFD calculation unit 21, generation of an approximate function by the approximate function generation unit 22, and calculation by the coupled calculation unit 23 described in the yet another embodiment (second calculation).

More specifically, in the first calculation, a surface temperature of a specific space is set as a plurality of input parameters. CFD calculation is performed by using the plurality of input parameters by the CFD calculation unit 21 to acquire a convective heat transfer coefficient on the surface portion of the specific space as a calculation result. With a combination of the calculation result by the CFD calculation unit 21 and the plurality of input parameters used in CFD calculation for calculating the calculation result being set as combination data, the approximate function generation unit 22 generates an approximate function for calculating a calculation result based on the plurality of input parameters by using a response surface methodology by an interpolation method or an approximation method based on the plurality of combination data. A thermal load of a predetermined period in the specific space is calculated by the coupled calculation unit 23 by convergent calculation using the calculation result obtained by applying the plurality of input parameters to the approximate function generated by the approximate function generation unit 22.

In the second calculation, with external thermal factors and internal thermal factors of the specific space being set as the plurality of input parameters in addition to the surface temperature of the specific space, CFD calculation is performed by using the plurality of input parameters by the CFD calculation unit 21 to acquire in-space temperature and humidity as a calculation result, for which the convective heat transfer coefficient on a surface portion of the specific space is taken into consideration. With a combination of the calculation result by the CFD calculation unit 21 and the plurality of input parameters used in CFD calculation for calculating the calculation result being set as combination data, the approximate function generation unit 22 generates an approximate function for calculating a calculation result of the plurality of input parameters by using a response surface methodology by an interpolation method or an approximation method based on the plurality of combination data. A thermal load of a predetermined period in the specific space is calculated by the coupled calculation unit 23 by using the calculation result obtained by applying the plurality of input parameters to the approximate function generated by the approximate function generation unit 22.

Specifically, calculation time of the first calculation is estimated as follows. First, when the input parameters include seven of indoor wall surface temperatures of those of six surfaces (surface temperatures of ceiling, wall, floor, and the like) and that of an indoor side surface temperature of a window of a room (specific space), the number of times of calculation is 124 from a rule of thumb. Here, assuming if one time/cycle of calculation takes 0.5 hour, calculation time by the CFD calculation unit 21 is 62 hours.

Time required for the convergent calculation of the coupled calculation unit 23 can be obtained from convergent calculation time per time× the number of calculation steps. The convergent calculation time per time is 0.000278 hour from a rule of thumb, and the number of calculation steps is 175200 times (=8760 hours (one year)/0.05 hour (unit calculation step)). Therefore, time required for the convergent calculation is 48.7 hours. Therefore, the calculation time for the first calculation can be described as 62 hours+48.7 hours=110.7 hours.

Calculation time of the second calculation is estimated as follows. First, when the number of the input parameters is 15 in total including indoor wall surface temperatures of six surfaces (surface temperatures of ceiling, wall, floor, and the like), an indoor side surface temperature of a window, outdoor wall surface temperatures of six surfaces (outdoor side surface temperatures of ceiling, wall, floor, and the like), an outdoor side surface temperature of the window of a room (specific space), and a solar radiation amount, the number of times of calculation is 344 from a rule of thumb. A basis of 344 times is that a multiway layout is 69 as 20% of entire sampling data, the number of random combinations is (square of the number of input parameters)+30=255, and the number of data for supplementing density of a sampling region is 20.

Here, when calculation time per time is set as 0.5 hour, calculation time by the CFD calculation unit 21 is 172 hours. Since the second calculation does not require convergent calculation as described in the yet another embodiment, the calculation time is 172 hours.

The selection unit 28 selects one of the first calculation and the second calculation in which the calculation time estimated by the calculation time estimation unit 27 is shorter. For example, in the example described above, the calculation time of estimation of the first calculation is 110.7 hours, and the calculation time of estimation of the second calculation is 172 hours. Therefore, in this example, the selection unit 28 selects the first calculation.

In this way, in the further embodiment, since calculation selected by the selection unit 28 is executed, the approximate function generation unit 22 generates the approximate function based on the calculation result of the CFD calculation unit 21 of the selected one of the first calculation and the second calculation.

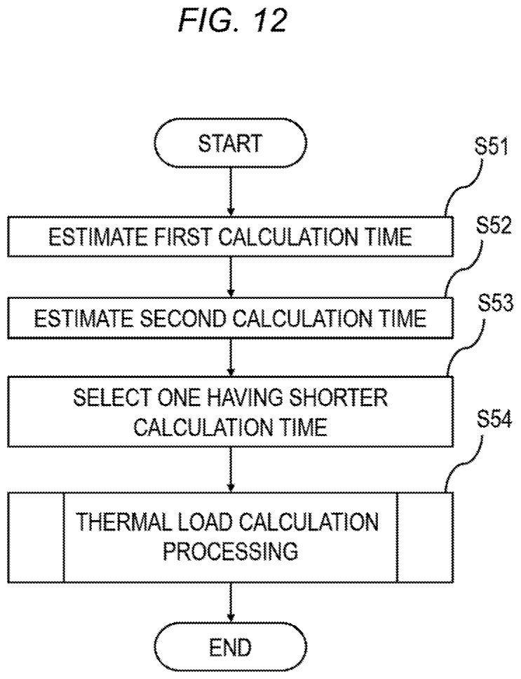

FIG. 12 is a flowchart illustrating processing by the thermal load calculation device 2 according to the further embodiment and shows calculation selection processing. First, when the approximate function has not been generated under the same conditions, the calculation time estimation unit 27 estimates calculation time by the first calculation (S51). Next, the calculation time estimation unit 27 estimates calculation time by the second calculation (S52).

Next, the selection unit 28 compares the calculation time estimated in step S51 with the calculation time estimated in step S52, and selects one having shorter calculation time (S53). Thereafter, thermal load calculation processing is executed by the calculation selected in step S53 (S54). In this processing, the processing shown in FIG. 6 is executed. When the first calculation is selected in step S53, the processing shown in FIG. 8 is executed in the processing of step S5 shown in FIG. 6. On the other hand, when the second calculation is selected in step S53, the processing shown in FIG. 10 is executed in the processing of step S5 shown in FIG. 6. Thereafter, the processing shown in FIG. 12 ends.

In this way, according to the thermal load calculation device 2 according to the further embodiment, the calculation load can be reduced at the time of thermal load calculation with higher accuracy.

Further, the one of the first calculation and the second calculation in which time required until end of the thermal load calculation is shorter is estimated in advance, and the approximate function is generated using the one by which the calculation time is estimated to be shorter than the other, so that the thermal load can be calculated in a shorter time.

The present invention has been described above based on the embodiments, but the present invention is not limited to the embodiments described above, and modifications may be added, and techniques of the embodiments or publicly known or commonly known techniques may be appropriately combined without departing from the spirit of the present invention.

For example, in the above embodiments, it is assumed that the specific space has a box shape, but it is not limited thereto, and it goes without saying that the number of input parameters changes according to the shape if the specific space has other shapes. Similarly, internal thermal factors and external thermal factors are not limited to those exemplified. In addition, an air conditioner used in the specific space may be included as an element to be considered as one of the conditions or input parameters. Further, the specific space may be a space obtained by further dividing a specific room within a building.

Further, in the above embodiments, since it is assumed that the specific space is partitioned by a wall or the like, the convective heat transfer coefficient is calculated, but when the specific space is adjacent to another space without being partitioned by a wall or the like, advection of air occurs between these spaces. Therefore, in such a case, it is preferable to calculate an advection amount of air instead of the convective heat transfer coefficient. In particular, when a part of the specific space is partitioned by a wall or the like and a remaining part is adjacent to another space without being partitioned by a wall or the like, it goes without saying that the convective heat transfer coefficient is calculated for the part, and the advection amount is calculated for the remaining part.

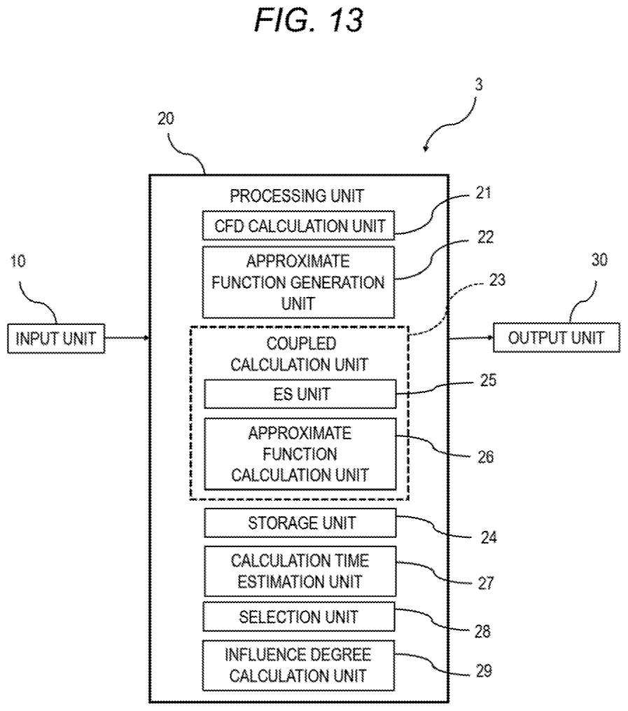

Further, the present invention may be configured as follows. FIG. 13 is a block diagram showing a thermal load calculation device according to a modification. As shown in FIG. 13, a thermal load calculation device 3 according to the modification may include an influence degree calculation unit 29. The influence degree calculation unit 29 calculates an influence degree of each input parameter with respect to a calculation result of CFD calculation. The influence degree calculation unit 29 calculates the influence degree of the input parameter based on, for example, the past results of CFD calculation based on how much the calculation results have changed when one input parameter is excluded. Since such an influence degree calculation unit 29 is included, the CFD calculation unit 21 performs CFD calculation with the input parameter, whose influence degree calculated by the influence degree calculation unit 29 is equal to or less than a predetermined setting value, being excluded. This is because the number of dimensions of CFD calculation can be appropriately reduced and the calculation load can be further reduced.

In addition, in the thermal load calculation devices 1 to 3 according to the present embodiments, a configuration corresponding to the CFD calculation unit 21 and the approximate function generation unit 22 may be provided outside in advance, and the generated approximate function may be stored in the storage unit 24. That is, the thermal load calculation devices 1 to 3 themselves may not have a function of generating the approximate function.

According to an aspect of the embodiments described above, a thermal load calculation device configured to calculate a thermal load in a specific space within a building over a predetermined period includes a CFD calculation unit configured to carry out a CFD calculation by using a plurality of first input parameters to obtain a first calculation result in which flow of air in the specific space is taken into consideration, the plurality of first input parameters being a plurality of thermal conditions affecting the specific space, an approximate function generation unit configured to generate an approximate function based on a plurality of combination data using a response surface methodology by an interpolation method or an approximation method, the appropriate function for calculating the first calculation result based on the plurality of first input parameters, each of the plurality of combination data being a combination of the first calculation result by the CFD calculation unit and the plurality of first input parameters used in the CFD calculation and a thermal load calculation unit configured to calculate the thermal load of the predetermined period in the specific space by using a second calculation result obtained by applying a plurality of second input parameters to the approximate function.

Each of the plurality of first input parameters may be a surface temperature of the specific space. The first calculation result may be at least one of a convective heat transfer coefficient (surface value) on a surface portion of the specific space and an air advection amount (surface value) between the specific space and an adjacent space. The second calculation result may be a value (surface value) obtained by applying the plurality of second input parameters to the approximate function.

The plurality of first input parameters may be at least one of external thermal factors and internal thermal factors of the specific space. The first calculation result may be a first in-space temperature and humidity. The second calculation may be a second in-space temperature and humidity obtained by applying the plurality of second input parameters to the approximate function.

The thermal load calculation device may further include a calculation time estimation unit configured to estimate time required for calculation of the thermal load by each of a first calculation and a second calculation, in which the first calculation includes the CFD calculation by the CFD calculation unit in which each of the plurality of first input parameters is a surface temperature of the specific space and in which the first calculation result is at least one of a convective heat transfer coefficient (surface value) on a surface portion of the specific space and an air advection amount (surface value) between the specific space and an adjacent space, the generation of the approximate function by the approximate function generation unit and the thermal load calculation by the thermal load calculation unit and in which the second calculation includes the CFD calculation by the CFD calculation unit in which the plurality of first input parameters are external thermal factors and internal thermal factors of the specific space in addition to the surface temperature of the specific space and in which the first calculation result is a first in-space temperature and humidity in which a convective heat transfer coefficient on the surface portion of the specific space in taken into consideration, the generation of the approximate function by the approximate function generation unit and the thermal load calculation by the thermal load calculation unit, and a selection unit configured to select one of the first calculation and the second calculation, the one having been estimated by the calculation time estimation unit to have shorter time required for calculation, in which the approximate function generation unit may be configured to generate the approximate function based on the first calculation result obtained by the CFD calculation unit in the one of the first calculation and the second calculation selected by the selection unit.

The thermal load calculation device may further include an influence degree calculation unit configured to calculate an influence degree of each first input parameter of the plurality of first input parameters with respect to the first calculation result of the CFD calculation. The CFD calculation unit may be configured to carry out the CFD calculation with the first input parameter whose influence degree calculated by the influence degree calculation unit is equal to or less than a predetermined value being excluded.

According to another aspect of the embodiments described above, a thermal load calculation device configured to calculate a thermal load in a specific space within a building over a predetermined period may include a storage unit configured to store a first calculation result and an approximate function, in which the first calculation result is obtained by a CFD calculation unit configured to carry out a CFD calculation by using a plurality of first input parameters to obtain the first calculation result in which flow of air in the specific space is taken into consideration, the plurality of first input parameters being a plurality of thermal conditions affecting the specific space and in which the approximate function is generated based on a plurality of combination data by using a response surface methodology by an interpolation method or an approximation method, the appropriate function for calculating the first calculation result based on the plurality of first input parameters, each of the plurality of combination data being a combination of the first calculation result and the plurality of first input parameters used in CFD calculation, and a thermal load calculation unit configured to calculate the thermal load of the predetermined period in the specific space by using a second calculation result obtained by applying a plurality of second input parameters to the approximate function stored by the storage unit.

What is claimed is:

1. A thermal load calculation device configured to calculate a thermal load in a specific space within a building over a predetermined period, comprising:
a CFD calculation unit configured to carry out a CFD calculation by using a plurality of first input parameters to obtain a first calculation result in which flow of air in the specific space is taken into consideration, the plurality of first input parameters being a plurality of thermal conditions affecting the specific space;
an approximate function generation unit configured to generate an approximate function based on a plurality of combination data using a response surface methodology by an interpolation method or an approximation method, the appropriate function for calculating the first calculation result based on the plurality of first input parameters, each of the plurality of combination data being a combination of the first calculation result by the CFD calculation unit and the plurality of first input parameters used in the CFD calculation; and
a thermal load calculation unit configured to calculate the thermal load of the predetermined period in the specific space by using a second calculation result obtained by applying a plurality of second input parameters to the approximate function.

2. The thermal load calculation device according to claim 1,
wherein each of the plurality of first input parameters is a surface temperature of the specific space,
wherein the first calculation result is at least one of a convective heat transfer coefficient on a surface portion of the specific space and an air advection amount between the specific space and an adjacent space, and
wherein the second calculation result is a value obtained by applying the plurality of second input parameters to the approximate function.

3. The thermal load calculation device according to claim 1,
wherein the plurality of first input parameters are at least one of external thermal factors and internal thermal factors of the specific space,
wherein the first calculation result is a first in-space temperature and humidity, and
wherein the second calculation is a second in-space temperature and humidity obtained by applying the plurality of second input parameters to the approximate function.

4. The thermal load calculation device according to claim 1, further comprising:
a calculation time estimation unit configured to estimate time required for calculation of the thermal load by each of a first calculation and a second calculation,
wherein the first calculation includes: the CFD calculation by the CFD calculation unit in which each of the plurality of first input parameters is a surface temperature of the specific space and in which the first calculation result is at least one of a convective heat transfer coefficient on a surface portion of the specific space and an air advection amount between the specific space and an adjacent space; the generation of the approximate function by the approximate function generation unit; and the thermal load calculation by the thermal load calculation unit, and
wherein the second calculation includes: the CFD calculation by the CFD calculation unit in which the plurality of first input parameters are external thermal factors and internal thermal factors of the specific space in addition to the surface temperature of the specific space and in which the first calculation result is a first in-space temperature and humidity in which a convective heat transfer coefficient on the surface portion of the specific space in taken into consideration; the generation of the approximate function by the approximate function generation unit; and the thermal load calculation by the thermal load calculation unit; and
a selection unit configured to select one of the first calculation and the second calculation, the one having been estimated by the calculation time estimation unit to have shorter time required for calculation,
wherein the approximate function generation unit is configured to generate the approximate function based on the first calculation result obtained by the CFD calculation unit in the one of the first calculation and the second calculation selected by the selection unit.

5. The thermal load calculation device according to claim 1, further comprising:
an influence degree calculation unit configured to calculate an influence degree of each first input parameter of the plurality of first input parameters with respect to the first calculation result of the CFD calculation,
wherein the CFD calculation unit is configured to carry out the CFD calculation with the first input parameter whose influence degree calculated by the influence degree calculation unit is equal to or less than a predetermined value being excluded.

6. A thermal load calculation device configured to calculate a thermal load in a specific space within a building over a predetermined period, comprising:
a storage unit configured to store a first calculation result and an approximate function,
wherein the first calculation result is obtained by a CFD calculation unit configured to carry out a CFD calculation by using a plurality of first input parameters to obtain the first calculation result in which flow of air in the specific space is taken into consideration, the plurality of first input parameters being a plurality of thermal conditions affecting the specific space, and
wherein the approximate function is generated based on a plurality of combination data by using a response surface methodology by an interpolation method or an approximation method, the appropriate function for calculating the first calculation result based on the plurality of first input parameters, each of the plurality of combination data being a combination of the first calculation result and the plurality of first input parameters used in CFD calculation; and
a thermal load calculation unit configured to calculate the thermal load of the predetermined period in the specific space by using a second calculation result obtained by applying a plurality of second input parameters to the approximate function stored by the storage unit.
